(19) United States
(12) Patent Application Publication
(10) Pub. No.: US 2021/0261324 A1
(43) Pub. Date: Aug. 26, 2021

(54) Alcohol Infused Coffee Pod Assembly

(71) Applicant: Kaleena Arnold, Marrero, LA (US)

(72) Inventor: Kaleena Arnold, Marrero, LA (US)

(21) Appl. No.: 16/802,253

(22) Filed: Feb. 26, 2020

(51) Int. Cl. B65D 85/804; C12G 3/06

(52) U.S. Cl. CPC B65D 85/8046; A47J 31/0668; C12G 3/06

(57) ABSTRACT

An alcohol infused coffee pod assembly for brewing a single cup of coffee with a pre-determined amount of alcohol includes a brewing cup which has an outer wall that is tapered between a top end and a bottom end of the brewing cup. In this way the brewing cup can be compatible with a single cup coffee brewing machine. A plurality of coffee grounds is contained within the brewing cup. In this way the coffee grounds are exposed to heated water for brewing coffee. An alcohol solution is infused into the plurality of coffee grounds thereby facilitating the alcohol solution to be released into the heated water for brewing coffee.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to coffee pod devices and more particularly pertains to a new coffee pod device for brewing a single cup of coffee with a pre-determined amount of alcohol.

### (2) Description of Related Art Including Information Disclosed Under 37 CFR 1.97 and 1.98

The prior art relates to coffee pod devices. The prior art discloses a coffee brewing cartridge and an additive cartridge that can be added to the coffee brewing cartridge. Additionally, the prior art discloses a dispenser for dispensing hot, cold or non-carbonated beverages into a consumer's beverage bottle. The prior art discloses a method of roasting coffee beans to facilitate the coffee beans to absorb a liquid additive. The prior art also discloses a disposable brewing cartridge that is comprised of biodegradable materials. The prior art also discloses a variety of coffee pods that have unique structural features for enhancing the brewing process.

### BRIEF SUMMARY OF THE INVENTION

An embodiment of the disclosure meets the needs presented above by generally comprising a brewing cup which has an outer wall that is tapered between a top end and a bottom end of the brewing cup. In this way the brewing cup can be compatible with a single cup coffee brewing machine. A plurality of coffee grounds is contained within the brewing cup. In this way the coffee grounds are exposed to heated water for brewing coffee. An alcohol solution is infused into the plurality of coffee grounds thereby facilitating the alcohol solution to be released into the heated water for brewing coffee.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an alcohol infused coffee pod assembly according to an embodiment of the disclosure.

FIG. 2 is a front cut-away view of an embodiment of the disclosure.

FIG. 3 is a detail view taken from circle 3 of FIG. 2 of an embodiment of the disclosure.

FIG. 4 is a perspective view of a whole coffee bean of an embodiment of the disclosure.

### DETAILED DESCRIPTION OF THE INVENTION

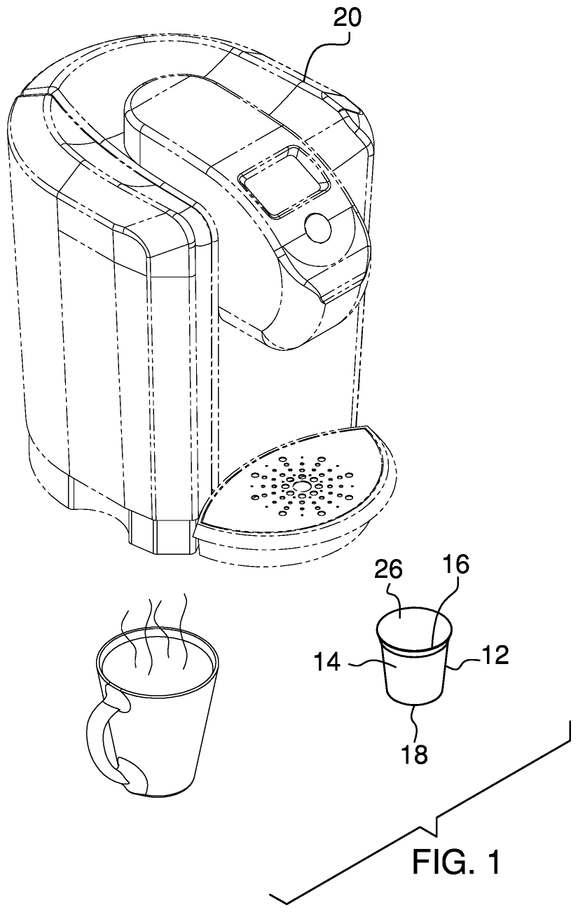

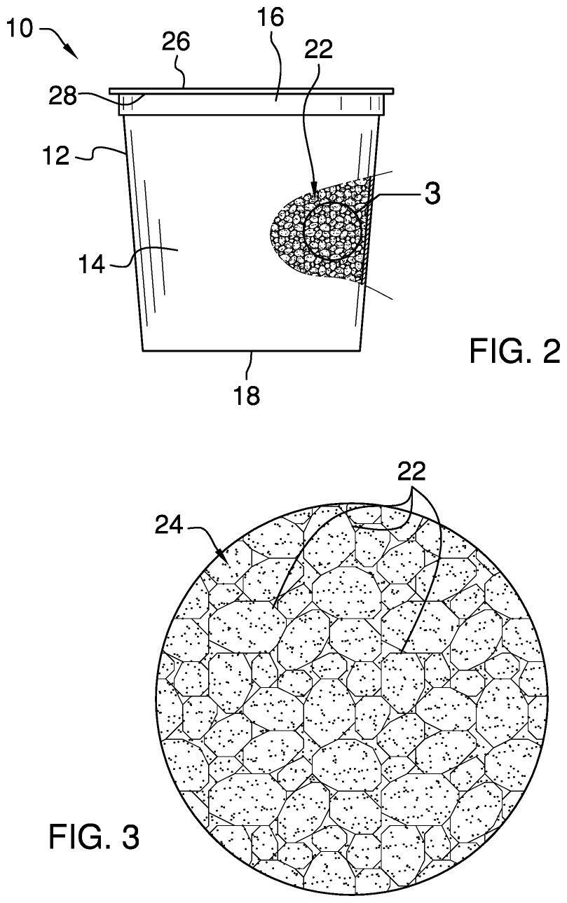

With reference now to the drawings, and in particular to FIGS. 1 through 4 thereof, a new coffee pod device embodying the principles and concepts of an embodiment of the disclosure and generally designated by the reference numeral 10 will be described.

As best illustrated in FIGS. 1 through 4, the alcohol infused coffee pod assembly 10 generally comprises a brewing cup 12 that has an outer wall 14 being tapered between a top end 16 and a bottom end 18 of the brewing cup 12. In this way the brewing cup 12 is compatible with a single cup coffee brewing machine 20, such as is manufactured by Keurig Dr. Pepper, 53 South Avenue, Burlington, Mass., 01803. The top end 16 is open and the bottom end 18 is closed. The brewing cup 12 is comprised of a fluid impermeable material to contain heated water from the single cup coffee brewing machine 20. Additionally, the brewing cup 12 is comprised of a material that can be punctured. In this way the brewing cup 12 can be punctured by a dispensing spout of the single cup coffee brewing machine 20.

A plurality of coffee grounds 22 is included and the plurality of coffee grounds 22 is contained within the brewing cup 12. In this way the coffee grounds 22 can be exposed to heated water for brewing coffee. The coffee grounds 22 may be ground coffee beans of any preferred species and flavor. An alcohol solution 24 is infused into the plurality of coffee grounds 22 thereby releasing alcohol in the heated water for brewing coffee. The alcohol solution 24 comprises ethanol thereby facilitating the alcohol to be safely consumed with the coffee.

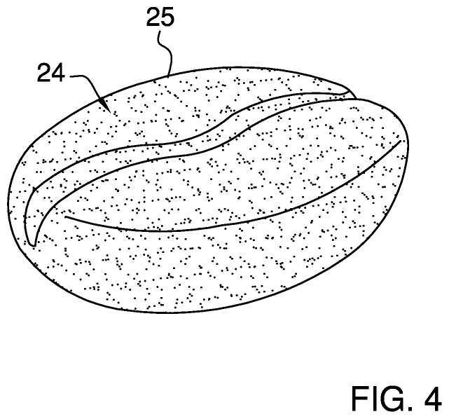

The alcohol solution 24 may include flavor additives, such as mocha, cream and other flavors associated with liqueurs that are commonly added to coffee. The alcohol solution 24 may be present in sufficient concentration to release approximately 0.3 ounces of alcohol, per 12.0 ounces of water, into the brewed coffee. In this way the alcohol content of the brewed coffee will be similar to adding a 1.5 ounce shot of liqueur to a traditionally brewed coffee. As is most clearly shown in FIG. 4, a whole coffee bean 25, rather than coffee grounds 22, may be infused with the alcohol solution 24.

A cover 26 is bonded to the top end 16 of the brewing cup 12 having the cover 26 completely covering the top end 16. In this way the coffee grounds 22 are retained in the brewing cup 12. The cover 26 is comprised of a fluid impermeable material to inhibit the alcohol solution 24 from evaporating during storage. Additionally, the cover 26 is comprised of a material that can be punctured to facilitate a water spout of the single cup coffee brewing machine 20 to puncture the cover 26. The cover 26 has a lower surface 28 and the lower surface 28 is bonded to the top end 16 of the brewing cup 12.

In use, the brewing cup 12 is placed into the brewing basket of the single cup brewing machine 20 and the single cup brewing machine 20 is turned on the brew the coffee. The alcohol solution 24 is released into the hot water during the coffee brewing process. In this way a user can enjoy a cup of coffee with alcohol added. Additionally, the single cup brewing machine 20 will be operated with normal operating procedures. The brewing cup 12 is removed from the brewing basket and is disposed of when the coffee is brewed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An alcohol infused coffee pod assembly having alcohol infused coffee ground therein for brewing a cup of coffee with alcohol for drinking, said assembly comprising:
a brewing cup having an outer wall being tapered between a top end and a bottom end of said brewing cup wherein said brewing cup is configured to be compatible with a single cup coffee brewing machine;
a plurality of coffee grounds, said plurality of coffee grounds being contained within said brewing cup wherein said coffee grounds are configured to be exposed to heated water for brewing coffee; and
an alcohol solution being infused into said plurality of coffee grounds wherein said alcohol solution is configured be released into the heated water for brewing coffee.

2. The assembly according to claim 1, wherein said top end is open, said bottom end being closed, said brewing cup being comprised of a fluid impermeable material wherein said brewing cup is configured to contain heated water from the single cup coffee brewing machine.

3. The assembly according to claim 1, wherein said brewing cup is comprised of a material that can be punctured wherein said brewing cup is configured to be punctured by a dispensing spout of the single cup coffee brewing machine.

4. The assembly according to claim 1, further comprising a cover being bonded to said top end of said brewing cup having said cover completely covering said top end thereby retaining said coffee grounds in said brewing cup.

5. The assembly according to claim 4, wherein said cover is comprised of a fluid impermeable material wherein said cover is configured to inhibit the alcohol solution from evaporating during storage.

6. The assembly according to claim 4, wherein said cover is comprised of a material that can be punctured wherein said cover is configured to be punctured by a water spout of the single cup coffee brewing machine, said cover having a lower surface, said lower surface being bonded to said top end of said brewing cup.

7. An alcohol infused coffee pod assembly having alcohol infused coffee ground therein for brewing a cup of coffee with alcohol for drinking, said assembly comprising:
a brewing cup having an outer wall being tapered between a top end and a bottom end of said brewing cup wherein said brewing cup is configured to be compatible with a single cup coffee brewing machine, said top end being open, said bottom end being closed, said brewing cup being comprised of a fluid impermeable material wherein said brewing cup is configured to contain heated water from the single cup coffee brewing machine, said brewing cup being comprised of a material that can be punctured wherein said brewing cup is configured to be punctured by a dispensing spout of the single cup coffee brewing machine;
a plurality of coffee grounds, said plurality of coffee grounds being contained within said brewing cup wherein said coffee grounds are configured to be exposed to heated water for brewing coffee;
an alcohol solution being infused into said plurality of coffee grounds wherein said alcohol solution is configured to be released into the heated water for brewing coffee; and
a cover being bonded to said top end of said brewing cup having said cover completely covering said top end thereby retaining said coffee grounds in said brewing cup, said cover being comprised of a fluid impermeable material wherein said cover is configured to inhibit the alcohol solution from evaporating during storage, said cover being comprised of a material that can be punctured wherein said cover is configured to be punctured by a water spout of the single cup coffee brewing machine, said cover having a lower surface, said lower surface being bonded to said top end of said brewing cup.

8. A method of brewing a cup of alcohol infused coffee, the steps of the method comprising:
providing a brewing cup being positionable in a single cup coffee brewing machine;
providing a plurality of coffee grounds;
providing an alcohol solution;
infusing said coffee grounds with said alcohol solution;
depositing said coffee ground infused with said alcohol solution into said brewing cup;
providing a cover;
bonding said cover to said brewing cup for closing said brewing cup thereby inhibiting said alcohol solution from evaporating; and
placing said brewing cup containing said coffee grounds infused with said alcohol solution into the single cup coffee brewing machine for brewing alcohol infused coffee.
